(19) United States
(12) Patent Application Publication
(10) Pub. No.: US 2012/0216933 A1
(43) Pub. Date: Aug. 30, 2012

(54) TIRE DESIGN FOR EASE OF INNER LINER REMOVAL AND METHOD THERE FOR

(75) Inventors: Metodi L. Ikonomov, Moore, SC (US); Cesar E. Zarak, Simpsonville, SC (US)

(73) Assignees: Societe de Technologie Michelin, Clermont-Ferrand (FR); Michelin Recherche et Technique S.A., Granges-Paccot (CH)

(21) Appl. No.: 13/037,338

(22) Filed: Feb. 28, 2011

(51) Int. Cl. B60C 5/18; B21D 53/26

(52) U.S. Cl. 152/450; 29/894.3

(57) ABSTRACT

A method of repairing a tire includes providing a tire for repair having an exterior with a tread, a mounting bead, and a sidewall therebetween, an interior including an inner layer having a desired inner layer thickness, and an elastomeric underlying tire layer beneath the inner layer, the inner layer comprising a plurality of ridges extending outwardly a desired height from the inner layer surface generally defining a plurality of inner layer segments, a portion of the underlying tire layer extending outwardly along the ridges, and may extend at least to the depth of the inner layer surface. Then, preparing a patch area by removing at least a portion of a plurality of the ridges around the perimeter of at least one inner layer segment exposing the raised portion of the underlying tire layer beneath the removed ridges, the exposed underlying tire layer forming a discontinuity in the inner layer around the formed perimeter, peeling the inner layer away from the underlying tire layer within the perimeter, and installing a tire patch onto the patch area.

### FIELD OF THE INVENTION

This invention relates generally to tires and tire repair, and more specifically to a method of preparing a surface of a tire for repair and a tire construction to accommodate said method.

### BACKGROUND OF THE INVENTION

Tires are susceptible to damage from various sources. Damage may occur when a tire encounters roadway damage, road debris such as trash, nails, glass, and stone, and during tire mounting and dismounting. Damage may occur on the inside or outside of the tire, or may penetrate the tire, such as a puncture or laceration. Further, the damage may occur along the tread area, the sidewalls, or the shoulders, which is the area between the tread area and a sidewall. A damaged tire portion generally refers to a portion of the tire needing repair, where the need may arise for any reason.

When repairing the damaged area of a tire, a patch is commonly used to cover and seal the damaged area. A patch is generally made of polymeric or elastomeric material, such as natural or synthetic rubber, and may include reinforcements within the patch such as metallic cables or synthetic cords. Tire patches may be adhesively affixed or cured to the tire.

In particular instances, the damaged area may be prepared before application of the patch. For certain patches, it may be desired to remove a portion of the inner liner of the tire before applying the patch. There remains a need for a method of removing a portion of the inner liner to facilitate repair of the tire and a tire construction to accommodate the method.

### SUMMARY OF THE DISCLOSURE

Disclosed is a method of repairing a tire comprising providing a tire for repair comprising a tread, a pair of mounting beads axially spaced along a rotational axis of the tire, and a sidewall extending between each mounting bead and the tread, an interior surface extending radially inward between each mounting bead, the interior surface including an elastomeric inner layer having a thickness and an exposed inner layer surface extending along the interior surface, the inner layer being arranged atop an elastomeric underlying tire layer, the inner layer comprising a plurality of ridges extending outwardly a desired height from the inner layer surface to generally define a plurality of inner layer segments each having a perimeter and arranged over at least a portion of the tire interior, the inner layer segments forming a portion of the tire interior surface, a portion of the underlying tire layer extending outwardly toward the ridges to form a raised portion of the underlying tire layer, where each ridge is at least partially filled with a portion of the inner layer, preparing a patch area by forming a discontinuity in the inner layer generally about the perimeter of at least one inner layer segment, which includes removing at least a portion of a plurality of the ridges defining the at least one inner layer segment, whereby said removal exposes the raised portion of the underlying tire layer beneath the at least partially removed ridges, the exposed underlying tire layer forming the discontinuity in the inner layer, peeling the inner liner away from the underlying tire layer within the perimeter, and installing a tire patch onto the patch area.

Also disclosed is a tire comprising a tread, a pair of mounting beads axially spaced along a rotational axis of the tire, and a sidewall extending between each mounting bead and the tread, an interior surface extending radially inward between each mounting bead, the interior surface including an elastomeric inner layer having a thickness and an exposed inner layer surface extending along the interior surface, the inner layer being arranged atop an elastomeric underlying tire layer, the inner layer comprising a plurality of ridges extending outwardly a desired height from the inner layer surface to generally define a plurality of inner layer segments each having a perimeter and arranged over at least a portion of the tire interior, the inner layer segments forming a portion of the tire interior surface, a portion of the underlying tire layer extending outwardly toward the ridges to form a raised portion of the underlying tire layer, where each ridge is at least partially filled with a portion of the inner layer, wherein removal of at least a portion of the ridges around the perimeter of a desired inner layer segment exposes the rasied portion of the underlying tire layer beneath the at least partially removed ridges forming a discontinuity in the inner layer generally about the perimeter of said one inner liner segment.

### BRIEF DESCRIPTION OF THE DRAWINGS

FIG. 1 is a perspective view of a tire of the present disclosure,

FIG. 2 is a partial cross sectional view through the tire of FIG. 1,

FIG. 3 is a partial perspective view showing the inner liner of the tire of FIG. 1,

FIG. 4 is a cross sectional view through section 4-4 in FIG. 2,

FIG. 5 is a detail view of the section 5 in FIG. 2,

FIG. 6A is a cross sectional view through section 6-6 in FIG. 5,

FIG. 6B is an alternative cross sectional view through section 6-6 in FIG. 5,

FIG. 7 is the cross sectional view of FIG. 6A showing ridges removed from the inner liner,

FIG. 8 is the cross sectional view of FIG. 7 showing a segment of the inner liner removed,

FIG. 9 is the cross sectional view of FIG. 8 showing portions of the adjacent ridges and inner liner removed by grinding,

FIG. 10 is a partial perspective view of the tire shown in FIG. 8 showing ridges removed from the inner liner and a segment of the inner liner removed,

FIG. 11 is a partial perspective view of the inside of the tire shown in FIG. 10 and a tire patch installed according to a method of the present disclosure, and

FIG. 12 is a partial cross sectional view through a diagrammatical representation of a tire molding device.

### DETAILED DESCRIPTION OF PARTICULAR EMBODIMENTS

The present disclosure provides a method for preparing a surface of a tire for repair and a tire construction to accommodate said method. Specifically, the damaged portion of the tire is prepared to facilitate repair by patching and/or filling the damaged portion. Portions of a tire may be repaired by applying patch material, such as, for example, a pre-formed patch and/or filler material, to said tire portion. In certain applications, a portion of the inner liner may be removed to facilitate repair of the tire prior to applying a patch.

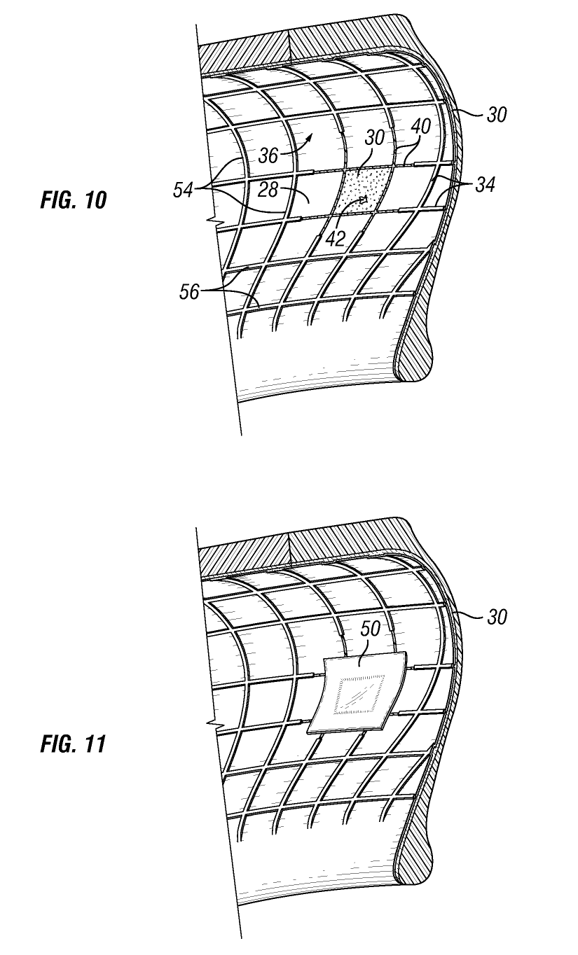

A method of repairing a tire is disclosed including the step of providing a tire for repair comprising a tread, a pair of mounting beads axially spaced along a rotational axis of the tire, and a sidewall extending between each mounting bead and the tread, an interior surface extending radially inward between each mounting bead, the inner surface including an elastomeric inner layer having a thickness and an exposed inner layer surface extending along the interior surface, the inner layer being arranged atop an elastomeric underlying tire layer, the inner layer comprising a plurality of ridges extending outwardly a desired height from the inner layer surface to generally define a plurality of inner layer segments each having a perimeter and arranged over at least a portion of the tire interior, the inner layer segments forming a portion of the tire interior surface, and a portion of the underlying tire layer extending outwardly toward the ridges to form a raised portion of the underlying tire layer. Further steps of such method include preparing a patch area by forming a discontinuity in the inner layer generally about the perimeter of at least one inner layer segment, which includes removing at least a portion of a plurality of the ridges defining the at least one inner layer segment, whereby said removal exposes the raised portion of the underlying tire layer beneath the at least partially removed ridges, the exposed underlying tire layer forming the discontinuity in the inner layer. The method includes peeling the inner layer away from the underlying tire layer within the perimeter of an inner layer segment, and installing a tire patch onto the patch area generally defined by the perimeter, such as shown in FIG. 10. The inner layer may be an inner liner of the tire.

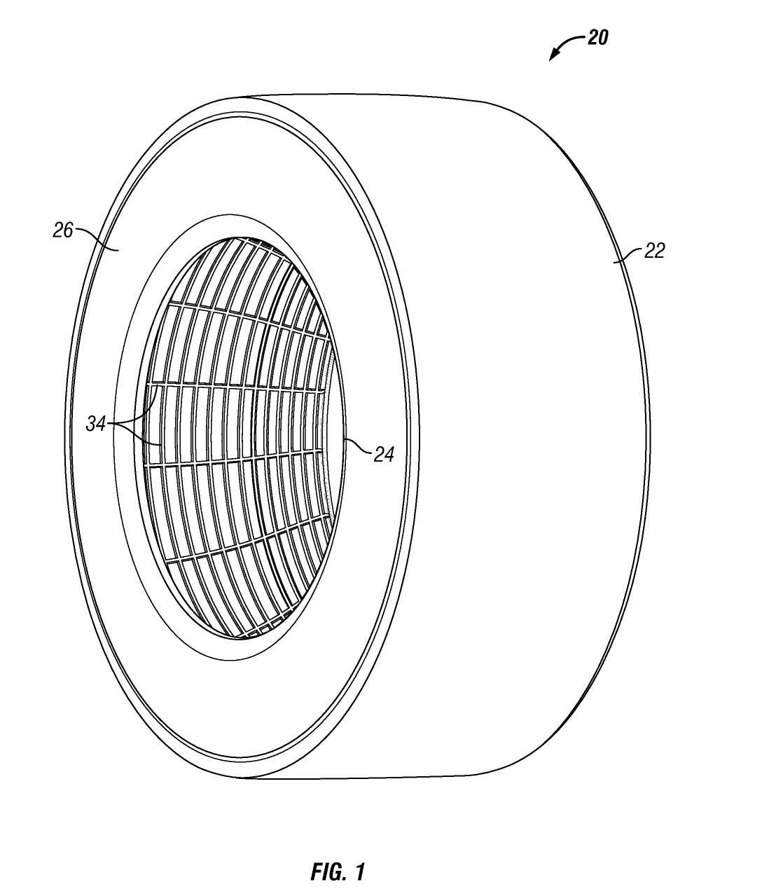

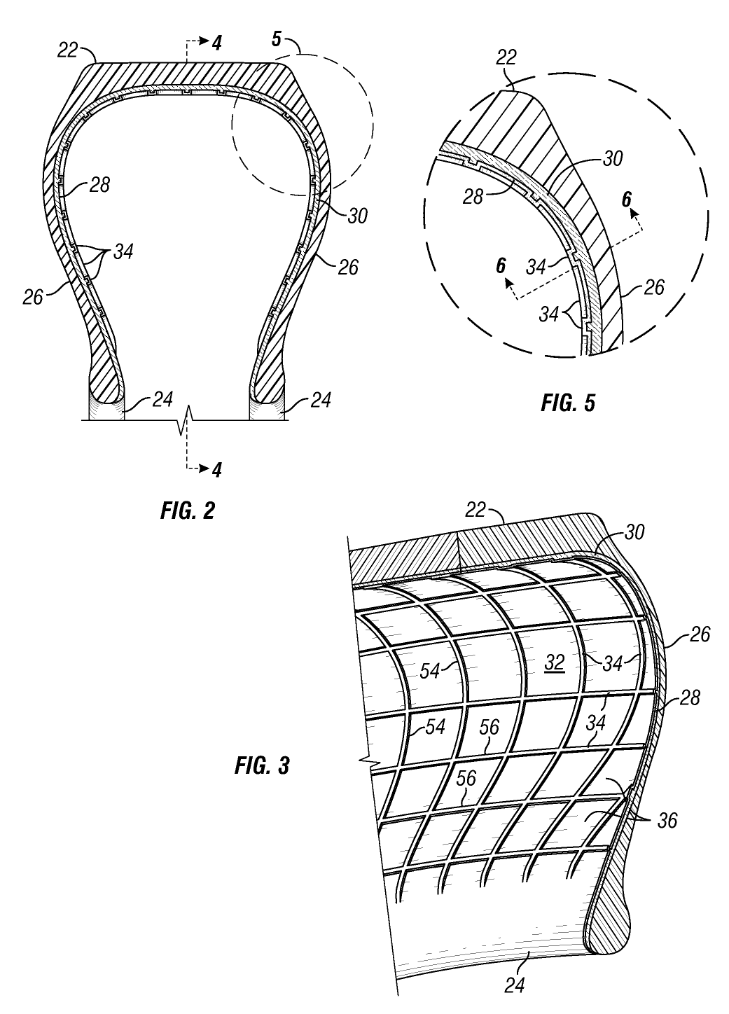

The step of providing a tire for repair may include providing a tire to facilitate the disclosed method of repair. An exemplary tire 20 is shown in FIG. 1 having a tread 22, a pair of mounting beads 24 axially spaced along a rotational axis of the tire, and a sidewall 26 extending between each mounting bead 24 and the tread 22. The interior surface of the tire extends radially inward between each mounting bead, the interior surface including an elastomeric inner layer 28 having a thickness and an exposed inner layer surface 32 extending along the interior surface, the inner layer 28 arranged atop an elastomeric underlying tire layer 30, such as shown in the detail in FIG. 5. The inner layer 28 may be an inner liner of the tire, for example. The tire 20 generally includes an exterior having the tread 22, the tread 22 typically extending annularly about a rotational axis of the tire. The exterior typically further includes the pair of the mounting beads 24 spaced laterally along the rotational axis of the tire for mounting the tire onto a wheel. A pair of opposing sidewalls 26 may generally extend between the mounting beads 24 to the tread 22. The tire 10 also includes an interior (i.e., an interior side) that comprises an interior exposed surface extending from a first mounting bead 24 on one side of the tire, up the back side of a sidewall, across the back side of the tread, and down the back side of the opposing sidewall until reaching the opposing mounting bead 24 on the other side of the tire, the interior and exterior sides or surfaces being generally separated by a thickness of the tire. In use, the exterior of the tire is exposed to atmosphere while the interior of the tire (i.e., the interior exposed surface) at least partially forms the pressurization chamber between the tire and wheel, where the interior exposed surface is exposed to pressurized fluid when the pressurization chamber is pressurized.

As shown in FIG. 3, the inner liner 28 includes a plurality of ridges 34 extending outwardly a desired height from the inner liner surface 32, such as in a desired pattern forming or defining a plurality of inner liner segments 36. A raised portion of the underlying tire layer 30 extending outwardly forms a riser 38 (also referred to as a “protrusion” along the underlying layer) within or below a ridge 34 and along a length of such ridges 34. It follows that beneath and along the ridges, a portion of the underlying tire layer may extend toward the inner liner surface 32, outwardly to a depth at least equal, level, or even with the inner liner surface 32 (i.e., even with the inner liner surface 32 as if it were extending through the ridge 34 or as if the ridge were not in existence), or even beyond the inner liner surface. As riser 38 extends outwardly from the underlying layer, riser 38 displaces a portion or strip of the inner liner 28 beneath the ridges 34. For example, the riser 38 may extend outwardly to a depth even with (i.e., coplanar, flush, equal, or level with) the inner liner surface 32. By further example, with reference to FIG. 6A, the riser 38 may extend outwardly to a depth beyond the inner liner surface 32 and into a thickness or height of the riser 38. Alternatively, as shown in FIG. 6B, the riser 38 may extend outwardly to a depth below the level of the inner liner surface 32. When the extended or raised portion of the underlying tire layer, i.e. the riser 38, extends beyond the level of the inner liner surface 32, removing at least a portion of a ridge 34 or the entire ridge 34 even with the level of the inner liner surface will cut through the riser 38 exposing the underlying tire layer. When the riser 38 extends approximately even with the level of the inner liner surface 32, removing the ridges 34 even with the level of the inner liner surface will expose the underlying tire layer of the riser 38. Finally, when the riser 38 extends to below the inner liner surface 32, an operator may use the ridges 34 as a cutting guide for removing the ridges and/or other material from the inner tire surface to a depth below the inner liner surface. In particular embodiments, such cutting exposes the riser and/or other portions of the underlying tire layer. Accordingly, the step of preparing the patch area may include removing material along the interior surface other than the ridges.

A plurality of ridges 34 may generally define at least one inner layer segment. In particular embodiments, one or more (or a plurality of) ridges 34 are discontinuous (i.e., a ridge may extend in a lengthwise direction in spaced apart segments to form an array), whereby each ridge only forms a portion of a perimeter of one or more inner layer segments, yet such ridges still define a perimeter of the one or more inner layer segments by the lengthwise extension of the array. In other embodiments, one or more (or a plurality of) ridges 34 are continuous, whereby the ridges form a perimeter of one or more inner layer segments, such as is generally shown in FIGS. 1, 3, 4, 10, and 11.

It is contemplated that the height of the risers 38 will vary with typical manufacturing process variability along the length of the ridges 34. In a preferred embodiment, the height of the riser 38 may be selected such that a majority of the risers 38 extend outwardly to a depth or distance within about 0.1 millimeter and 2 millimeters of the inner liner surface, i.e. above or below the inner liner surface. Alternatively, the height of the riser 38 may be selected such that a majority of the risers 38 have a height extending within about 0.2 millimeter and 1.0 millimeter of the inner liner surface, i.e. above or below the inner liner surface. Removing a ridge portion by cutting into the riser 38 forms a separation 40 of the inner liner from one side of the removed ridges to the other.

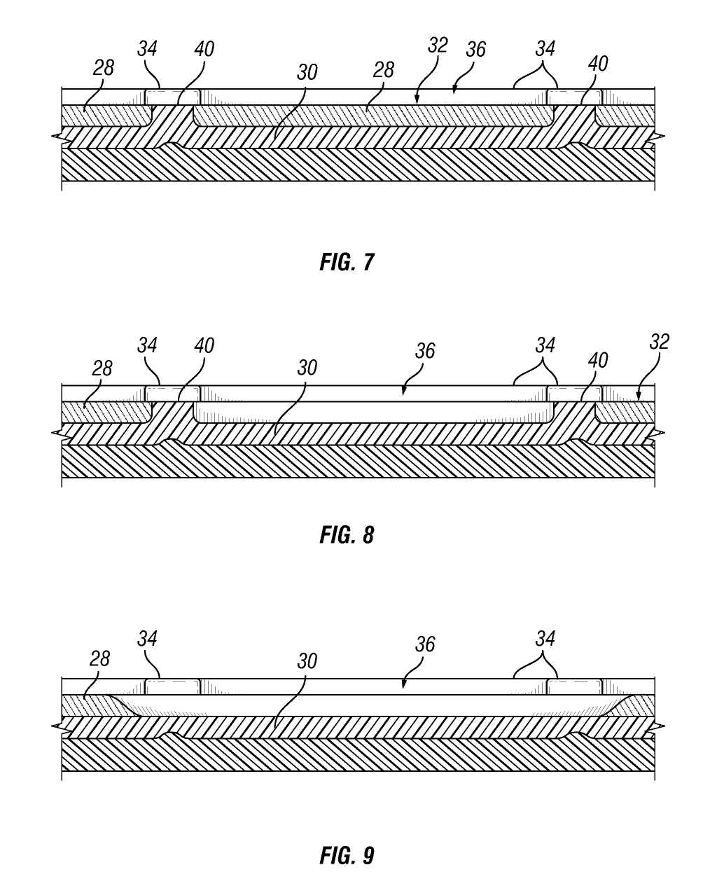

Typically, the ridges 34 in the patch area are removed to the inner liner surface such as shown in FIGS. 7 though 10 to provide a patch area free of ridges. Alternatively or additionally, as shown in FIG. 9, the area or perimeter surrounding the removed inner liner area or the patch area may be beveled or tapered. For certain applications, a portion or all of the ridge height may remain in the patch area outside of the perimeter of the inner liner segment or segments removed.

Due to process variation, it is contemplated that the height of the riser in the ridges may be less than the thickness of the inner liner. When the height of the riser is less than the thickness of the inner liner (i.e., the riser does not reach a depth even with the inner liner surface), the method of repairing a tire may include the step of removing a plurality of ridges and a portion of the inner liner therebeneath to form a perimeter around at least one inner liner segment exposing the riser of the underlying tire layer beneath the removed ridges. Ridges and associated inner liner are removed until the riser of the underlying tire layer is exposed forming the separation around the perimeter of the desired inner liner segment or segments to be removed. Accordingly, the step of preparing the patch area includes removing material along the interior surface other than the ridges.

In one embodiment of the method, such as shown in FIGS. 7 through 10, a plurality of ridges 34 from the inner liner 28 may be removed to form a perimeter around at least one inner liner segment 36. When the ridges 34 are removed about a perimeter of an inner liner segment 36, the underlying tire layer 30 is exposed where the riser 38 is cut, forming a discontinuity or separation 40 along the inner liner, which extends about the perimeter. Alternatively, the ridges 34 may be removed to form a discontinuity in the inner liner along a perimeter circumnavigating two or more inner liner segments 36. For example, ridges 34 may be removed to form a perimeter around four inner liner segments 36. In summary, a discontinuity in the inner liner may for a perimeter about any number of inner liner segments as desired to form a patch area that accommodates any size and location of tire damage 42 for repair.

After the ridges 34 are cut through the risers 38 to thereby form the separation 40 of the inner liner from one side of the removed ridges to the other around the desired inner liner segments 36, the method includes peeling the inner liner 28 from the underlying tire layer 30 using sufficient force to separate the bond between the inner liner 28 and the underlying tire layer 30 as shown in FIGS. 8 and 10.

Then, as shown in FIG. 11, the method includes installing a tire patch 50 onto the patch area. In one alternative, one tire patch may be used to cover the patch area as shown in FIG. 11. In this alternative, the tire patch 50 may be installed onto the exposed underlying tire layer 30 shown in FIG. 10 and to the surrounding inner liner 28 in the patch area with at least partially removed ridges. Alternatively, the step of installing a tire patch may include: (1) installing a first patch over the underlying tire layer 30 within the area of the removed inner liner segment, and then (2) subsequently installing a second patch over the first patch and the surrounding inner liner 28 in the patch area. The first patch may have a size and shape corresponding to the shape of the removed inner liner segment filling 75% or more of the area of the removed inner liner segment. Alternatively, the first patch may have a size and shape filling a majority of the area of the removed inner liner segment.

The ridges 34 such as shown in FIG. 6 may have a height in a range from about 0.5 to 5 millimeters. Alternatively, the ridges 34 may have a height between about 1.5 and 3 millimeters. The width of the ridges may be from about 1 to 10 millimeters. Alternatively, the width of the ridges may be between about 3 and 6 millimeters. In one example, the height of the ridges is about 2 millimeters and the width of the ridges is about 4 millimeters. The height and width of the ridges may be selected to provide the risers 38 along the ridges 34 having a desired height as discussed above. The height and width of the ridges may be determined empirically based on the tire molding process. For example, when the height of the riser 38 is selected such that a majority of the risers 38 have a height between about 0.2 and 1.0 millimeter greater than the thickness of the inner liner, the width and height of the risers may be increased or decreased in the mold until the desired riser height is provided.

In particular embodiments, the inner liner may have a thickness typically between about 0.5 and 4 millimeters. It is contemplated that a relationship between the height and width of the ridges and the average inner liner thickness between the ridges will satisfy the following relationship:

average liner thickness=(C/ridge width)×(ridge width+2×ridge height) where C is greater than 0.2.

The pattern of inner layer segments may be arranged over at least a portion of the tire interior surface. In particular embodiments, the pattern of inner layer segments may be arranged along at least a portion of the sidewalls of the tires. Alternatively, the pattern of inner layer segments may be arranged along at least a portion of the tire interior under the tread. In yet another alternative, the pattern of inner layer segments may be arranged along at least a portion of the shoulder between the sidewalls and the tread.

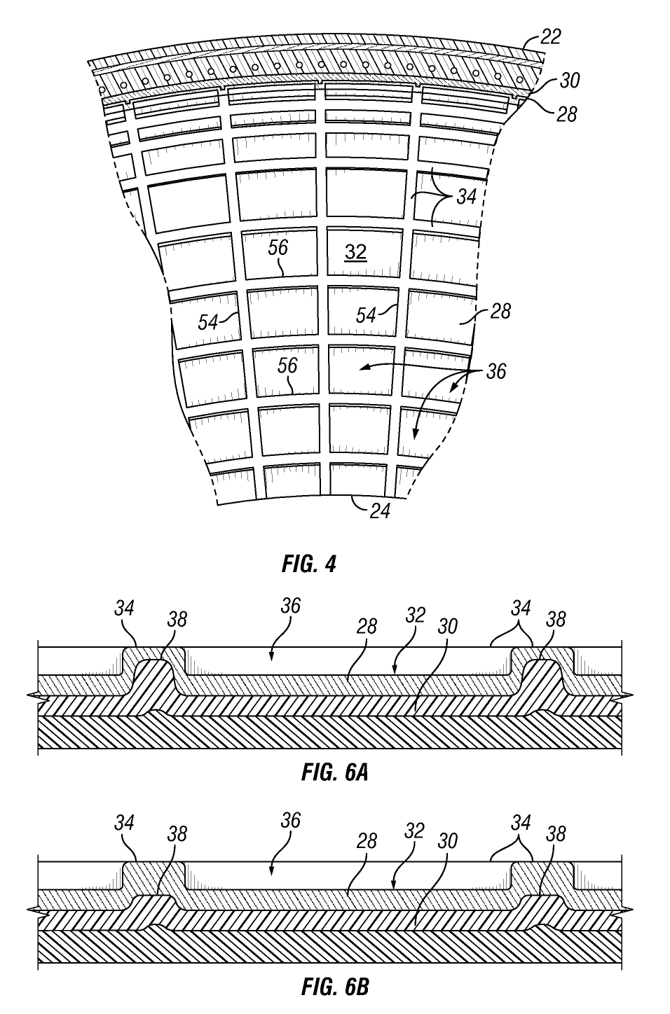

To facilitate the formation of patch areas and removal of inner liner segments of a desired size, the ridges 34 may be formed in a pattern of inner liner segments having a desired size and shape. In the embodiment of FIG. 3, the plurality of ridges 34 comprise radially extending ridges 54 and circumferentially extending ridges 56, which generally form a pattern of trapezoidal or polygonal inner liner segments along the sidewalls and approximately rectangular or polygonal inner liner segments along the underside of the tread. In the example shown in FIGS. 3 and 4, the radially extending ridges may be spaced between about 5 and 80 millimeters apart, which may increase as the ridges extend radially from a bead area toward the sidewall and the center axial centerline of the tire. Alternatively, the radially extending ridges may be spaced between about 20 and 40 millimeters apart measured at the mounting bead. In one example, the radially extending ridges may be spaced between about 25 and 30 millimeters apart measured at the mounting bead. The circumferentially extending ridges may be spaced between about 10 and 80 millimeters apart. Alternatively, the circumferentially extending ridges may be spaced between about 25 and 50 millimeters apart. In yet another alternative, the circumferentially extending ridges may be spaced between about 30 and 40 millimeters apart.

In alternative embodiments, the radially extending ridges may extend in a skewed or biased direction in a path that crosses circumferentially extending ridges or in a path crossing other skewed ridges forming approximately triangular and other geometric shaped inner liner segments. Alternatively, the circumferentially extending ridges may extend in a skewed or biased direction in a path that crosses radially extending ridges or in a path crossing other skewed ridges. In yet another alternative, the ridges may extend in arcuate directions to form inner liner segments of a generally arcuate polygon shape having a desired number of arcuate sides. It is contemplated that any pattern of ridges may be provided in the inner liner to form any desired shape of inner liner segments, including polygonal, circular, semi-circular, arcuate, elliptical, or other desired shapes generally having a size for forming a desired patch area. In particular embodiments, at least a portion of the ridges may be discontinuous such that transverse ridges do not intersect. For example, at least one of the transverse ridges may have a discontinuity where the paths of the ridges cross.

The inner liner is formed of an elastomeric material such as butyl rubber that is formable into the ridges. The underlying tire layer may be a plurality of layers and materials along different portions of the tire. However, at least a portion of the underlying tire layer is formed of an elastomeric material that is formable into the extended riser portions along the ridges. The underlying layer may include an elastomeric ply with or without reinforcements. The underlying layer may include a body ply and/or sidewall ply, for example, and may comprise one or more tire components or layers radially and/or circumferentially arranged. In particular embodiments, the underlying layer may comprise one form in the sidewall area and a different form along the under-tread or shoulder area.

The ridges may be removed from the inner liner cutting through the risers using any tool known in the art, such as an abrading tool having an abrading or cutting member selected as desired for the application. The abrading tool may be a disc abrasive, a rotary or non-rotary cutting tool, a fly cutter, rotary or non-rotary abrading tool, brush, hot wire cutter, or other abrading or shaping tool selected to remove the ridges. Alternatively, the abrading tool may include a cutting tool comprising cutting, abrading, shaving, planing, scraping, brushing, and/or other abrading or shaping configurations. The abrading tool may include a rasp, shaver, abrader, brush, regroover, or other tool. The abrading tool may include abrasives such as aluminum oxides, silicon carbide, zirconia/alumina, diamond, cubic boron nitride, and/or other abrasives.

The presently disclosed tire may be formed using any method known in the art. In particular embodiments, the method of forming a tire may include providing a tire molding device comprising a first mold portion adapted to shape one side of the exterior of a tire comprising a first tread portion, a first mounting bead, and a first sidewall therebetween, a second mold portion adapted to shape the opposite side of the exterior of the tire comprising a second tread portion, a second mounting bead, and a second sidewall therebetween, and an inner mold having an inner mold surface adapted to form the interior surface of the tire, the interior surface of the tire extending radially inward between each mounting bead, the tire interior surface including an elastomeric inner layer having a thickness and an exposed inner layer surface extending along the interior surface and contacting the inner mold, the tire inner layer being arranged atop an elastomeric underlying tire layer, and providing a plurality of channels formed in the inner mold surface having a size and position adapted to form a plurality of corresponding ridges extending outwardly a desired height from the inner layer surface to generally define a plurality of inner layer segments each having a perimeter and arranged over at least a portion of the tire interior, a portion of the underlying tire layer extending outwardly toward the ridges to form a raised portion of the underlying tire layer. Then, enclosing a tire pre- form in the first and second cavities, applying the inner mold on the interior of the tire forming the tire against the first mold portion and the second mold portion, and forming a plurality of ridges in the inner liner of the tire extending outwardly a desired height from the inner liner surface to generally define a plurality of inner layer segments each having a perimeter and arranged over at least a portion of the tire interior, the inner liner segments forming a portion of the tire interior surface, a portion of the underlying tire layer extending outwardly toward the ridges to form a raised portion of the underlying tire layer, where each ridge is at least partially filled with a portion of the inner layer. The plurality of channels formed in the inner mold surface may have a size and position adapted to form a portion of the underlying tire layer extending outwardly along the ridges at least to the level of the inner liner surface.

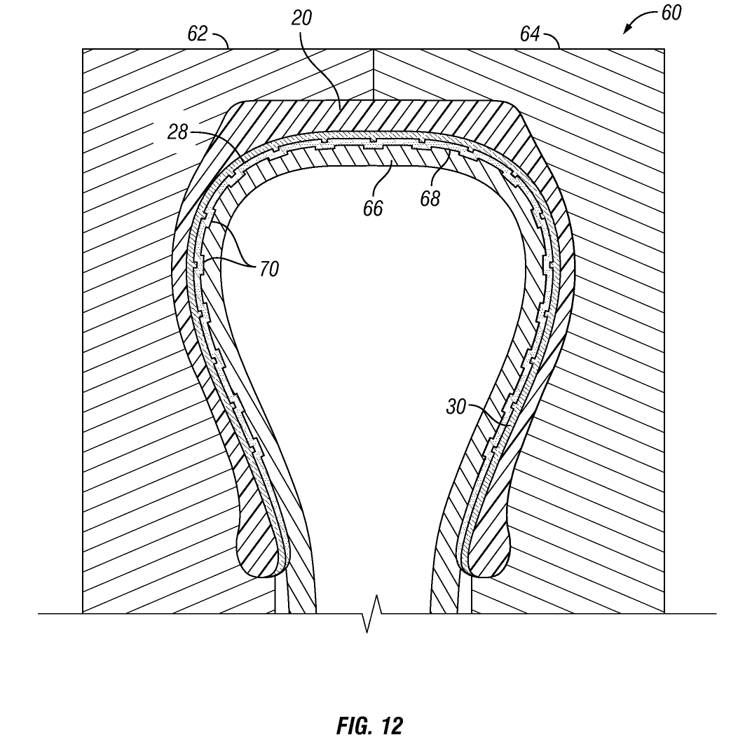

The presently disclosed tire may be formed using any molding device known in the art. A diagrammatical representation of one embodiment of tire molding device 60 for use with the method of forming a tire is shown in FIG. 12, comprising a first mold portion 62 adapted to shape one side of the exterior of a tire comprising a first tread portion, a first mounting bead, and a first sidewall therebetween, and a second mold portion 64 adapted to shape the opposite side of the exterior of the tire comprising a second tread portion, a second mounting bead, and a second sidewall therebetween. The tire molding device 60 includes an inner mold 66 having an inner mold surface 68 adapted to form the tire against the first mold portion and the second mold portion and to form ridges along inner liner surface. The interior tire surface includes an elastomeric inner liner having an exposed inner liner surface contacting the inner mold and a desired inner liner thickness, and an elastomeric underlying tire layer beneath the inner liner. The inner mold 66 includes a plurality of air venting channels 70 formed in the inner mold surface 68, the plurality of channels 70 having a size and position adapted to receive and form a plurality of ridges extending outwardly a desired height from the inner liner surface generally defining a plurality of inner liner segments, a portion of the underlying tire layer extending outwardly along the ridges displacing a strip of the inner liner beneath the ridges. The plurality of channels formed in the inner mold surface may have a size and position adapted to form a portion of the underlying tire layer extending outwardly along the ridges at least to the level of the inner liner surface.

The plurality of channels in the inner mold surface may include radially extending channels and circumferentially extending channels forming the ridges in the inner liner of the tire to form inner liner segments.

In one embodiment, the inner mold is an inflatable bladder having desired surface features, i.e. channels, for use with the tire molding device. The inflatable bladder may include a bladder outer surface adapted to apply pressure on the interior of a tire in a tire molding device, the interior of the tire comprising an elastomeric inner liner having an exposed inner liner surface contacting the bladder and a desired inner liner thickness, and an elastomeric underlying tire layer beneath the inner liner, the bladder comprising a plurality of channels formed in the outer surface, the plurality of channels having a size and position adapted to form a plurality of ridges extending outwardly a desired height from the inner liner surface in a pattern forming a plurality of inner liner segments, a portion of the underlying tire layer extending outwardly along the ridges displacing a strip of the inner liner beneath the ridges. The plurality of channels formed in the bladder outer surface may have a size and position adapted to form a portion of the underlying tire layer extending outwardly along the ridges at least to the level of the inner liner surface.

In the molding operation, a tire pre-form is placed in the mold and the inner mold applied against the interior of the tire. The tire molding device is heated to cure the tire, and the added heat also improves the shaping of the tire. Air that is entrapped between the inner liner of the tire and the inner mold surface or bladder outer surface enters the air venting channels and flows to a vent outlet. The application of heat and pressure causes the tire, including the inner liner and the underlying tire layer beneath the inner liner to soften and flow into the channels of the mold surface forming the ridges on the inner liner corresponding to the channels on the inner mold surface. As the inner liner material and the underlying tire layer material flows into the air venting channels, the underlying tire layer 30, with reference to FIG. 6, extends into the ridges 34 to form the risers 38 along a length of ridges 34.

The height of the riser in the ridges of the inner liner of the tire depends in part on the size of the channels. The height and width of the channels, and thereby the ridges, may be selected such that a majority of the risers extend outwardly to a level within about 0.1 and 2 millimeter of the inner liner surface, i.e. above or below the inner liner surface. Alternatively, the height of the riser may be selected such that a majority of the risers have a height within about 0.2 and 1.0 millimeter of the inner liner surface, i.e. above or below the inner liner surface. The plurality of channels may include radially extending channels and circumferentially extending channels forming the ridges on the inner liner of the tire to form inner liner segments. The circumferentially extending channels may be spaced to form the ridges from about 10 to 80 millimeters apart. Alternatively, the circumferentially extending channels may be spaced to form the ridges from about 25 to 50 millimeters apart on the inner liner of the tire. The radially extending channels may be spaced to form the ridges from about 5 to 80 millimeters apart measured at the mounting bead. Alternatively, the radially extending channels may be spaced to form the ridges from about 20 to 40 millimeters apart measured at a mounting bead portion of the tire.

The air venting channels may have a depth adapted to form ridges of a height between about 1.5 and 3 millimeters. Additionally, the channels may have a width adapted to form ridges of a width between about 3 and 6 millimeters. The depth and width of the channels may be selected to provide ridges with risers along the ridges having a desired height at least the thickness of the inner liner as discussed above. The depth and width of the channels may be determined empirically based on the ability of the channel to vent excess air trapped in the tire molding process, as well as the molded geometry of the ridges and corresponding risers. It is contemplated that the depth of the channels may be between about 1.5 and 4 millimeters in the inflated bladder, and the width of the channels may be between about 3 and 7 millimeters in the inflated bladder.

While this invention has been described with reference to particular embodiments thereof, it shall be understood that such description is by way of illustration and not by way of limitation. Accordingly, the scope and content of the invention are to be defined only by the terms of the appended claims.

What is claimed is:

1. A method of repairing a tire comprising steps of:
providing a tire for repair comprising:
a tread, a pair of mounting beads axially spaced along a rotational axis of the tire, and a sidewall extending between each mounting bead and the tread,
an interior surface extending radially inward between each mounting bead, the interior surface including an elastomeric inner layer having a thickness and an exposed inner layer surface extending along the interior surface,
the inner layer being arranged atop an elastomeric underlying tire layer, the inner layer comprising a plurality of ridges extending outwardly a desired height from the inner layer surface to generally define a plurality of inner layer segments each having a perimeter and arranged over at least a portion of the tire interior, the inner layer segments forming a portion of the tire interior surface,
a portion of the underlying tire layer extending outwardly toward the ridges to form a raised portion of the underlying tire layer, where each ridge is at least partially filled with a portion of the inner layer,
preparing a patch area by forming a discontinuity in the inner layer generally about the perimeter of at least one inner layer segment, which includes removing at least a portion of a plurality of the ridges defining the at least one inner layer segment, whereby said removal exposes the raised portion of the underlying tire layer beneath the at least partially removed ridges, the exposed underlying tire layer forming the discontinuity in the inner layer,
peeling the inner layer away from the underlying tire layer within the perimeter, and installing the tire patch onto the patch area.

2. The method of claim 1, where in the step of providing a tire, the portion of the underlying tire layer extending outwardly toward the ridges extends at least to a depth even with the inner layer surface.

3. The method of claim 1, where in the step of providing a tire, wherein the plurality of ridges form the perimeter of each of the plurality of inner layer segments.

4. The method of claim 1, where in the step of providing a tire, the inner layer comprises an inner liner of the tire.

5. The method of claim 1, wherein the step of preparing the patch area includes removing material along the interior surface other than the ridges.

6. The method of claim 1, where in the step of providing a tire, the underlying tire layer comprises a plurality of different discrete portions arranged along the inner tire surface, where said portions comprise different tire components.

7. The method of claim 1, the step of providing a tire, where the plurality of ridges comprise radially extending ridges and circumferentially extending ridges.

8. The method of claim 6, where the circumferentially extending ridges are spaced from about 10 to 80 millimeters apart.

9. The method of claim 6, where the radially extending ridges are spaced from about 5 to 80 millimeters apart.

10. The method of claim 1, where the step of preparing a patch area further comprises:
removing the plurality of ridges around the perimeter of a plurality of inner layer segments.

11. The method of claim 1, where in the step of providing a tire, the height of the ridges is in a range from about 0.5 to 5 millimeters, and the width of the ridges is in a range from about 1 to 10 millimeters.

12. A tire comprising:
a tread, a pair of mounting beads axially spaced along a rotational axis of the tire, and a sidewall extending between each mounting bead and the tread,
an interior surface extending radially inward between each mounting bead, the interior surface including an elastomeric inner layer having a thickness and an exposed inner layer surface extending along the interior surface, the inner layer being arranged atop an elastomeric underlying tire layer,
the inner layer comprising a plurality of ridges extending outwardly a desired height from the inner layer surface to generally define a plurality of inner layer segments each having a perimeter and arranged over at least a portion of the tire interior, the inner layer segments forming a portion of the tire interior surface,
a portion of the underlying tire layer extending outwardly toward the ridges to form a raised portion of the underlying tire layer, where each ridge is at least partially filled with a portion of the inner layer,
wherein removal of at least a portion of the ridges around the perimeter of a desired inner layer segment exposes the raised portion of the underlying tire layer beneath the at least partially removed ridges forming a discontinuity in the inner layer generally about the perimeter of said one inner liner segment.

13. The tire of claim 12, where the portion of the underlying tire layer extending outwardly along the ridges extends at least to a depth equal with the inner layer surface.

14. The tire of claim 12, wherein the plurality of ridges form the perimeter of each of the plurality of inner layer segments.

15. The tire of claim 12, where the inner layer comprises an inner liner of the tire.

16. The tire of claim 12, where the underlying tire layer comprises a plurality of different discrete portions arranged along the inner tire surface, where said portions comprises different tire components.

17. The tire of claim 12, where the plurality of ridges comprise radially extending ridges and circumferentially extending ridges.

18. The tire of claim 17, where the circumferentially extending ridges are spaced from about 10 to 80 millimeters apart.

19. The tire of claim 17, where the radially extending ridges are spaced from about 5 to 80 millimeters apart.

20. The tire of claim 12, where the height of the ridges is in a range from about 0.5 to 5 millimeters, and the width of the ridges is in a range from about 1 to 10 millimeters.
